(19) United States
(12) Patent Application Publication
(10) Pub. No.: US 2016/0155072 A1
(43) Pub. Date: Jun. 2, 2016

(54) METHODS AND SYSTEMS FOR TRANSPORTATION OF OBJECTS AND PEOPLE THROUGH COLLABORATION NETWORKS OF PEOPLE CONNECTED VIA TRUST RELATIONSHIPS

(71) Applicants: Andreas-Leonidas PRODROMIDIS, Marousi (GR); Lampros MOUSSELIMIS, Zografos (GR); Apostolos DAILIANAS, Marousi (GR); Nikolaos PAPASPYROU, Athens (GR)

(72) Inventors: Andreas L. Prodromidis, Marousi (GR); Lampros Mousselimis, Zografos (GR); Apostolos Dailianas, Marousi (GR); Nikolaos Papaspyrou, Athens (GR)

(21) Appl. No.: 14/905,009

(22) PCT Filed: Jul. 14, 2014
(86) PCT No.: PCT/US14/46513

§ 371 Date: Jan. 14, 2016

(30) Foreign Application Priority Data
Jul. 12, 2013 (GR) 20130100414

(51) Int. Cl. G06Q 10/06; G06Q 50/32; G06Q 50/00

(52) U.S. Cl. CPC G06Q 10/06311; G06Q 50/01; G06Q 50/32

(57) ABSTRACT

Methods and systems allow for the creation, management and use of networks of people that trust each other in order to enable them to collaborate to transport objects or people. Information of users wishing to send objects or people is matched thereby with people having the capability to perform the transportation.

### CROSS-REFERENCE TO RELATED APPLICATION

This application claims the benefit of Greek Patent Application 20130100414, filed on Jul. 12, 2013, the contents of which are herein incorporated by reference in their entirety.

### FIELD OF THE INVENTION

The invention concerns methods and systems for the collection, processing, management and communication of the necessary information in order to match users' requests to transport objects or people from one location to another, with other people that are trusted by the users and can effect the transportation.

### BACKGROUND OF THE INVENTION

Traditionally, people either decide to carry out the transportation of an object themselves, especially if it concerns transportation within the same city/area, or they pay the post office, a courier company or a shipping company to ship it on their behalf. Similarly, people either drive between two locations, e.g., if they need to go somewhere themselves (or their children, etc.), or they use taxi services or the mass transport system.

While one could theoretically ask a trusted friend to provide transport, it is impractical to try to locate, in a systematic and organized way, which of the trusted people can help transport objects between two locations. Unless one was willing to a put a friend to a potentially serious degree of inconvenience, one would presumably prefer to only ask friends who just happened to be going the same way. However, absent a lucky accident, one would have to contact all the people he trusts in order to find an appropriate one that moves along a suitable route. It is clearly impractical to perform such an action multiple times, efficiently, repeatedly or in a large scale; it doesn't exist as a practice, nor does it take place anywhere in the world.

There exist several bulletin-board type solutions providing car-pooling matching services, such as carpooling.com, roadsharing.com, liftshare.com, or uber.com, or more generally, physical or electronic listings of classifieds of people and/or companies that advertise demand or supply of certain services. However, such listings fail to take into account trust, and do not provide for the movement of objects other than people. With the sender and receiver not knowing the carrier and the carrier not knowing the sender and receiver, both sides are taking safety risks. Third party services connecting unknown people cannot protect against thefts (e.g., if the carrier, who is unknown to the sender and receiver decides to keep the object himself/herself), nor can they protect against illegal transportation of goods (in case the sender, who is unknown to the carrier, decides to use the carrier to send illegal goods). Transporting objects with the least costs specifically requires that people are personally trusted (e.g., personal friends, colleagues, etc.) or implicitly trusted (e.g., certified or authorized) and happen to move along the requested routes anyway.

Some previous efforts unrelated to transportation attempt to associate trust and social networks, although none of them aims to create pairs of people to directly collaborate with each other, based on the uni-directional assignment of trust of one person to the other. Examples include:
The assignment of a level of trust to people that is relevant to their reputation and popularity with respect to certain subjects (e.g., when they rate other people, products, etc.), in order to be used by search engines (WO/2012/109487—Social Network Based Contextual Ranking),
The ranking and presentation of results of search engines, that takes into account content evaluations and judgments of users and their trusted social networks. (KR/1020070084579—Search System and Methods With Integration of User Judgments Including Trust Networks),
The assumed trust between two non-connected users of a social network (WO/2008/094155—System and Method for Determining a Trust Level in an Social Network Environment), for example if two non-connected users are tagged in a picture.
The use of the word “trust” in the context of security of computing resources, services, or even the acceptance of refusal of electronic messages or emails (WO/2008/094155—System and Method for Developing and Using Trusted based Policy on a Social Model EP/1282289—Mechanism for trusted relationships in decentralized networks EP/1591939—Social Network Email Filtering).

It will be appreciated, however, than none of these examples would facilitate the transportation of goods or people based on trust-relationships, or even remotely suggest how such transportation could be reasonably accomplished.

### SUMMARY OF THE INVENTION

In view of the foregoing, it is an object of the present invention to provide methods and systems for the creation, management and use of networks of people that trust each other in order to enable them to collaborate to transport objects or people, one for another. The combination of methods and systems for the creation, management and use of networks of people with trust relationships among them, with the methods and systems for the matching of information of users wishing to send objects or people with people having the capability to perform the transportation, offers several advantages that will be better appreciated in view of the disclosure herein.

An advantage of this invention is its systematic capability to locate people that can transport other people or their objects or goods, while safeguarding against the risk of theft (the carrier is a person of trust of the sender) and the risk of transporting illegal goods (the carrier knows and/or selects which people she can assist). In particular, this invention facilitates the simple and common need of people to transport objects and/or people and/or other living beings (e.g., pets) to other locations, without having to turn to postal, courier, shipping or other transportation-related companies and without having to carry out the itinerary themselves (and thus spending the respective transportation time and costs). Instead, it capitalizes on networks of people of trust and their itineraries in order to identify those people of trust that happen to have already scheduled to carry out related routes and are willing to assist to the particular need.

This invention blends social networks, trust relationships and crowd-sourcing for shipping and transportations services. Further, it helps identify the best people for transporting other people or goods with the least costs (including the least consumption of resources).

This invention can be applied within the postal, courier and shipping services industry, as well as the transportation services industry. It capitalizes and builds upon the new trends of the sharing economy, social networking and crowd-sourcing to enable connected people with trust relationships to participate, request, and/or provide the above services depending on the particular case and provided they have the capability.

The present invention includes methods and systems for the centralized collection, management, processing and communication of information for the creation and/or management and/or use of networks of people with trust relationships among them to enable them to collaborate and to facilitate each other when they need to send objects or transport people between two locations.

Specifically, exemplary embodiments and aspects can include the following:
1. The use of computers or mobile communication devices (mobile/portable communication devices) through which a user can define other people he trusts for the transportation of objects and/or the transportation of people.
2. A method and system that receives the information that each user inputs, regarding the people he trusts forming his Trusted Circle.
3. The use of computers or mobile communication devices (mobile/portable communication devices) through which users input their need to send an object or transport a person (e.g., themselves, their child, their parent etc.) from location A to location B within a certain time frame.
4. A method and a system that issues a request to people in the user's Trusted Circle, asking them to transport the stated object or person from location A to location B at the designated time frame, if they have the ability (e.g., if it doesn't significantly alter their plans).
5. The use of computers or mobile communication devices (mobile/portable communication devices) through which users indicate their availability to transport objects or transport people from a location A to a location B within a certain time frame.
6. A method and system for sending information and instructions to the computers and/or mobile communication devices of these users with respect to:
   the result of the matching of the requests of the users that need to transport objects or people with the most appropriate users, as per their availability statements,
   the contact information and the necessary communications that need to take place between the matched users,
   the steps and details that pertain to the transportation per se,
   any possible post-transportation steps that users need to follow.

These and other objects, aspects and advantages of the present invention will be better understood in view of the drawings and following detailed description of preferred embodiments.

### BRIEF DESCRIPTION OF THE DRAWINGS

FIG. 1 is a schematic overview of component interactions whereby a User of the invention defines her Trusted Circle by specifying one or more people she trusts;

FIG. 2 is a schematic overview of component interactions whereby a User searches within his Trusted Circle a person that can accommodate his need to transport of an object between locations;

FIG. 3 is a schematic overview of component interactions whereby users declare the locations that are convenient for them, and/or the routes they perform, in order to be selected for facilitating other users that trust them, when these other users wish to transport objects close to these location and/or routes;

FIG. 4 is a schematic overview of an alternate version of the component embodiments of FIG. 2;

FIG. 5 is a schematic overview of a further alternate version of the component embodiments of FIG. 2;

FIG. 6 is a flow diagram of process steps associated with the component interactions of FIG. 1;

FIG. 7 is a flow diagram of process steps associated with the component interactions of FIG. 2;

FIG. 8 is a flow diagram of process steps associated with the component interactions of FIG. 3; and

FIG. 9 is a flow diagram of process steps associated with the component interactions of FIG. 5.

### DETAILED DESCRIPTION OF PREFERRED EMBODIMENTS

The present invention pertains to the necessary methods and systems that enable users find easily and systematically people they trust that can help them transport objects or people between two locations on their behalf.

The following paragraphs describe the necessary system for the implementation of this invention. The separation of the system in computational units/subsystems is indicative and representative. Those skilled in the art will readily appreciate the logical and functional equivalence of different designs and implementations, notably through systems based on object-oriented design, or through distributed systems or systems based on services (Service-Oriented), or systems based on events/incidents processing (Event-Driven), or systems that use Internet technologies, and/or mobile systems, and for systems/tools for the automation of processes (Business Process Automation and Management Systems & Tools) or rules (Rule-based).

Furthermore, the reference on users is not binding in regards to the people that receive the invitations to transport object or persons. It is fully compatible with the invention, to have other people—initially unassociated with the invention—receive invitations to transport objects or persons and be able to accept or to reject them and/or communicate (through the invention) with the users that trust them.

Additionally, while, hereinafter, it is assumed that the sender of an object is the user of the invention, it may well be that the user of the invention is the recipient of the object and it can be he who initiates the transportation request of an object from another location to his location. The methods and systems described herein are fully compatible with this case as well.

The systems that are described herein can coexist and complement methods and systems implementing social networks, publishing ads and mapping and driving directions services.

In the preferred embodiment of the invention, the user of the invention indicates the people entrusted to transport objects in order to send them an invitation to transport a particular object, as well the origin and destination locations and the desired timeframe. The invention sends the appropriate messages to people the user trusts. These people accept or reject the specific transportation request according to their ability to facilitate the user. For example, some of them may have planned to carry out a relevant itinerary already or may have some availability and can decide to help. In any case, the invention alerts the user and the person that accepted the invitation and instructs them about the transportation details.

A preferred embodiment of this invention is comprised of the following:
1. An Information Gateway server (2), indicatively, Web server, IVR server, SMS/IMS/MMS Gate server, Email server, call center server, etc.
2. A Member Repository (3), indicatively, database server, file server or other repository server, maintaining all data pertaining to members.
3. Trust Network Repository (4), indicatively, database server, file server or other repository server, maintaining the information pertaining to the trust relationships among the people in the network.
4. Trust Network Analysis & Processing server (5), indicatively, application or similar type server, etc.
5. Pending Send Requests Repository) (7) indicatively, database server, file server or other repository server, maintaining all pending requests from users and their status.
6. Send and Transport Processing server (8), indicatively, application or similar type server, etc.
7. Matching Repository (9), indicatively, database server, file server or other repository server, maintaining all matching results.
8. Communication Devices (1), for the communication of the users with the above servers. Indicative such devices are mobile phones, personal computers, laptops or tablets, PDAs (Personal Digital Assistants), special vehicle-mounted devices attached to vehicles, location-aware mobile communication devices with or without specialized application software to support this invention, devices that have been specially construed to support this invention, etc. Such communication can be achieved in many ways, notably through special software designed for the particular invention, through third-party messaging/communication systems (e.g., Facebook or Google+, of Skype messages, etc.), through messages (indicative SMS), multimedia messages (MMS), instant messages (Instant Messaging—IMS), email (email), TCP/IP, Internet-based Protocols (indicative HTTP, WAP, etc.), Mobile Communication Protocols (indicative GPRS, GSM, etc.), specialized applications, Voice (e.g., IVR).

These Communication Devices are used by the users for the following:
i. To submit their registration requests to become users of the invention.
ii. To define the people they trust
iii. To submit their requests to search for people that can transport their objects, defining the object(s) they wish to transport, one or more origin and destination locations, and the desired time frame.
iv. To receive invitations asking them to consider transporting objects (on behalf of users that trust them).
v. To respond positively or negatively to received invitations
vi. To receive “match found” notifications or rejections to their invitation requests
vii. To receive contact information and instructions to help them synchronize and communicate for the pickup and delivery steps.
viii. To communication for clarifications, support, account information, etc.

The term “computer device” is used herein to generically refer to any device including a hardware processor capable of executing program instructions stored in a tangible memory medium, and encompasses both the various servers and communications devices described above.

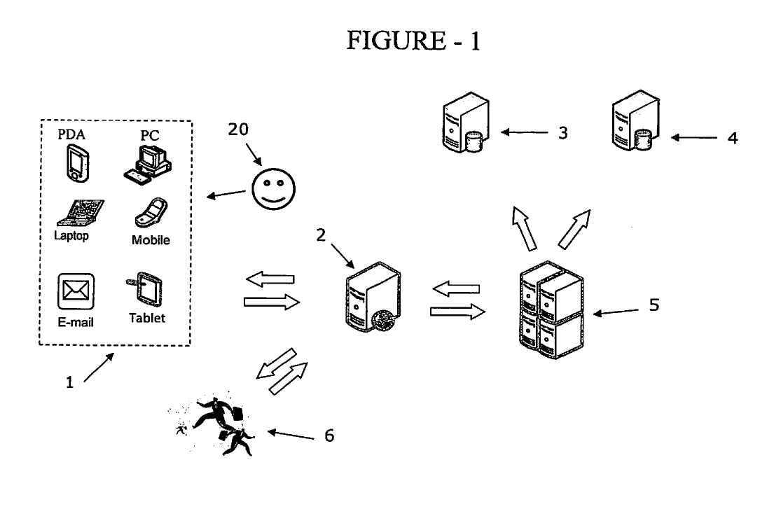

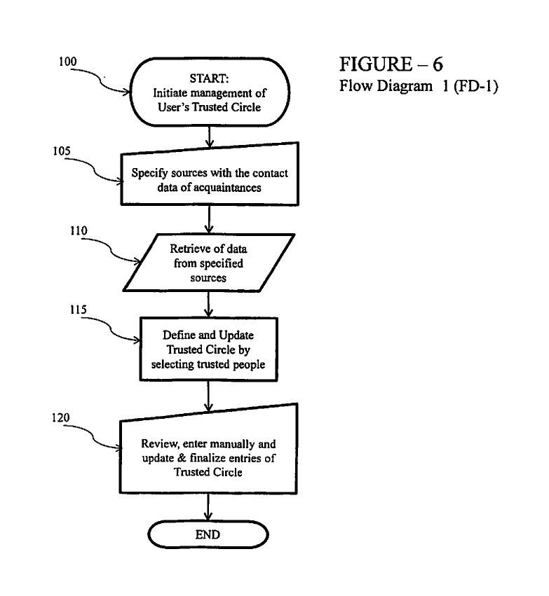

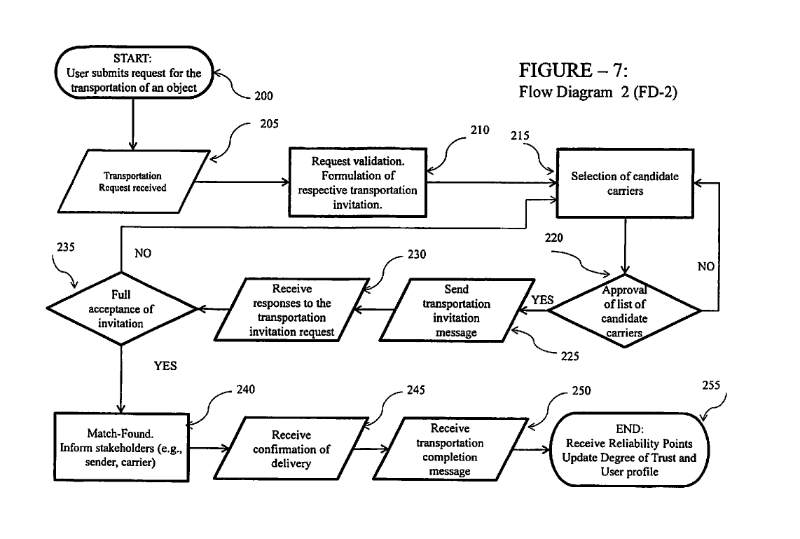

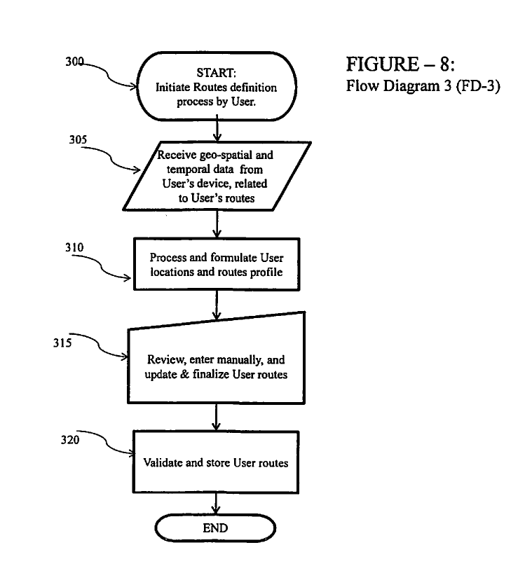

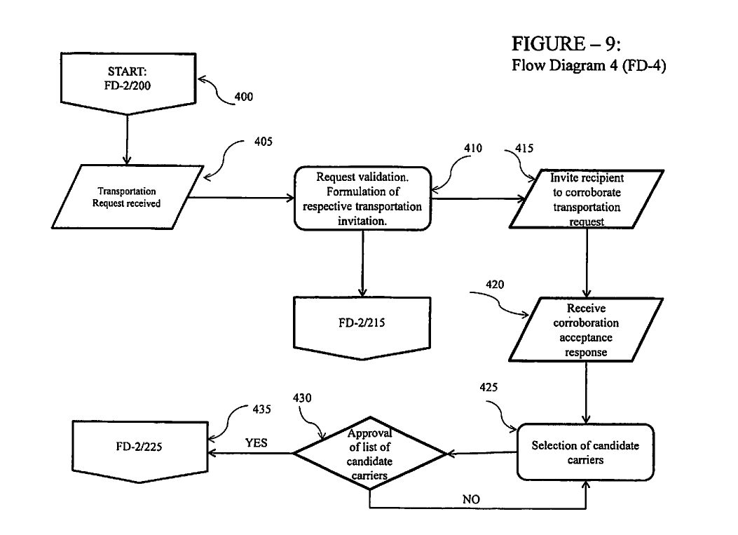

The invention may be understood by way of example and with reference to FIGS. 1-9, of which Flow Diagrams (FIGS. 6-9—referred to herein as FD-1 through FD-4 respectively) show the basic steps of the method, while FIGS. 1-5 present the key components of the system and the communications between them.

### Embodiment 1

FD-1 and FIG. 1 describe the process by which a registered User (20) of the invention defines her Trusted Circle by specifying one or more people she trusts, regardless of whether they are users of the invention or not. The registration process creates a personal account for the User (20) in order to facilitate her occasional or frequent use of the invention. The process of creating a personal account is standard in the industry of e-commerce and/or the industry of provisioning of electronic services through the Internet, hence it is not described herein.

Through the Communication Device (1) (FD-1/100) (via wired or wireless network communications, the Internet, phone network, etc.), the User (20) specifies (FD-1/120) the necessary data for the people she trusts (users or not). In this embodiment, and for simplicity and the gradual disclosure of the invention, it is assumed that the User (20) specifies the people of her Trusted Circle manually. The steps FD-1/105, FD-1/110, FD-1/115 of the method, that enable the automated creation and updating of the Trusted Circle, will be revealed in another embodiment.

The necessary data specified for trusted people includes some or all of the following items:
i. Demographics (e.g., name)
ii. Contact details (e.g., phone, address, email)

This information is received by the Information Gateway server (2), which examines it for completeness and forwards it to the Trust Network Analysis & Processing server (5). This server (5) checks the list for correctness (e.g., if data is missing, if any data is already there from a previous registration, etc.), marks the trust relationship between the user and the people specified, and stores them into the Trust Network Repository (4).

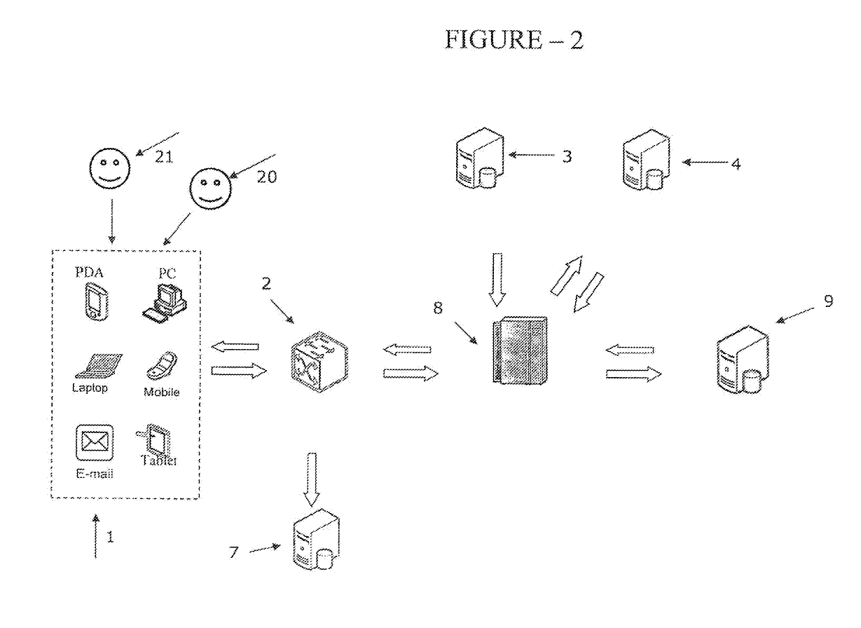

FD-2 and FIG. 2 describe the process whereby a User (20) searches within his Trusted Circle a person (user or not) that can accommodate his need to transport of an object from location A to location B. Through her communication device (1), the User (20) sends (via a special application, email, message, SMS, etc.) a request for the transportation of an object (FD-2/200), including the following information:
1. Type and characteristics of the object, including its size, weight and information that needs to be taken into consideration during transportation (e.g., if it is fragile, if it is sensitive to temperature, etc.)
2. One or more origin locations and their respective convenient pickup times
3. One or more destination locations and their respective convenient delivery times
4. Date by which the pickup and/or delivery of the object must by fulfilled and/or the frequency the transportation, if it pertains to a recurring need.

The request is received (FD-2/205) by the Information Gateway server (2) and examined for its validity (FD-2/210). Then, it is forwarded to the Send and Transport Processing server (8) and stored in the Pending Send Requests Repository (7).

Subsequently, the Send and Transport Processing server (8) forwards the invitation for the transportation of the object, through the Information Gateway server (2) to everyone within the Trusted Circle of the User (20) (FD-2/225), regardless of whether they are users of the invention or not, based on information she had entered in the Trust Network Repository (4). In this embodiment, and for simplicity and the gradual disclosure of the invention, there is no separate reference to steps FD-2/215 and FD-2/220. Instead, they are assumed to have been carried out in step FD-1/120. Under this assumption, all people in the Trusted Network of the User (20) are considered selected and confirmed candidates for the requested transportation. Steps FD-2/215, FD-2/220, will be revealed in detailed in another embodiment.

After receiving an invitation to transport an object, each person in the Trusted Circle of the User (20) can choose to send via the Communication Device (1), either an acceptance response to carry out the requested transportation, also denoting the most convenient location and time for the pick-up and delivery of the object, or a negative response. In both cases, the acceptance or refusal response is received (FD-2/230) by the Information Gateway server (2), examined for its validity and origination and forwarded to the Send and Transport Processing server (8). Depending on the response per se (step FD-2/235), the Send and Transport Processing server) (8):
i. Notes the User (20)'s request as satisfied, if it is an acceptance response or
ii. Notes the specific refusal, if it is a negative response, but maintains the request as pending, until it receives an acceptance response by another person, or until the requested delivery time for the specific object is exceeded.

In the former case (acceptance response), the Send and Transport Processing server (8) deletes the record pertaining to this request from the Pending Send Requests Repository (7), updates the Matching Repository (9) with the positive outcome, and sends the respective “match found” message to the User (20), who had submitted the request for the transportation of the object, and the Person (21) of her Trusted Circle who had responded positively (FD-2/240).

The above “match found” messages communicate to the two recipients the fact that Person (21) of the Trusted Circle of the User (20) had agreed to help User (20) and transport the requested object from location A and B. The “match found” messages may also contain information necessary for the fulfillment of the request, such as the pickup and delivery locations, days and hours as selected by Person (21), instructions, driving directions, etc. As with previous communications, the “match found” and respective informational messages are sent to the two recipients through the Information Gateway server (2). Like earlier, for the sake of understanding and gradual disclosure of the invention, this embodiment does not reveal steps FD-2/245, FD-2/250, FD-2/255. Instead, they will be presented in following embodiments.

### Embodiment 2

In a variation of the preferred embodiment of the invention, the User (20) defines, updates or complements his Trusted Circle with people he trusts leveraging, in an automated way, existing sources, e.g., from websites/social networking companies, personal address or phone books, personal e-mailing lists, etc., and then modifies it as necessary by adding or deleting people.

In the implementation of this variation, the methods and systems of the invention are amended only for the part where the User (20) defines or updates his Trusted Circle (see FIG. 1). Specifically, the invention is modified so that:
1. The User (20) can specify an External Source (6) where he keeps the data of the people he trusts (FD-1/105), via his Communication Devices (1) and via a wired or wireless communication network, the Internet, phone, etc.,
2. The User (20) can interface with the said External Source (6) in order to retrieve the said data (FD-1/110) (e.g., the names of people),
3. It validates the retrieved data (e.g., if data is missing and must be completed, if certain data is already in the system from an earlier retrieval, etc.), it marks the trust relationship between the User (20) and the people retrieved, and stores them in the ‘Trust Network Repository (4) (FD-1/115).
4. It provides the User (20) the capability to review and modify the information within his Trusted Circle and to modify or delete it, at his discretion (FD-1/120).

In all other respects (testing, processing, storage and use of data entered), the methods and systems of the invention remain the same.

### Embodiment 3

In an enriched variation of the above embodiments, the people who can potentially transport objects can themselves be users of the invention and declare in advance specific locations, routes, and potential timeframes in which they can offer their services. The invention can exploit this information to automatically select the user that will satisfy a particular transport request.

In this case, the invention additionally:
1. Accommodates the use of a “Communication Device” (1) through which the users declare their availability to transport objects close to a location A, or close to a route from a location A to a location B, and/or potentially at a specific time or within specific timeframes.
2. Provides a method and system for collecting, storing and processing the information about locations, routes, and/or potential specific times and timeframes that the users declare.
3. Provides a method and system for matching the above information with the corresponding information in the request of the user that wants to transport an object, in order to automatically locate the most appropriate available trusted user that can transport the requested object (according to criteria such as distance and/or compatible timeframes).

In this enriched embodiment of the invention, the system additionally comprises the following (from this point on, for abbreviation reasons, the declared location and routes, along with the optional timeframes and schedules, will be referred to as “routes”):
1. The supplementary capability of the “Information Gateway Server” (2) to accept the declaration of availabilities to transport objects, potentially in specific routes and timeframes.
2. A “Locations & Routes Processing server” (10) that can process the declarations of specific routes of users.
3. A “Locations & Routes Repository” (11).
4. A “Locations & Routes Matching server” (12) that matches transportation requests with the routes of users trusted by the initiator of the request.

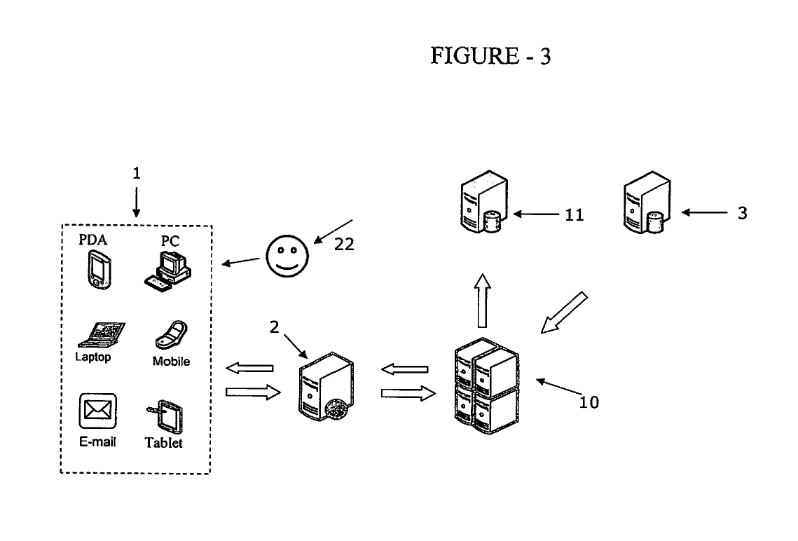

The variation of the invention can be fully understood with the help of an example, and reference to FD-3 and the attached Figures. FD-3 and FIG. 3 depict the process through which users (22) declare the locations that are convenient for them, and/or the routes they perform, in order to be selected for facilitating other users that trust them, when these other users wish to transport objects close to these location and/or routes. Through the [symbol] Communication Device [symbol] (1), the aforementioned users (22) declare the locations that they frequently visit, along with the timeframes they frequently visit these locations, or location that they know in advance they will visit (FD-3/315). In this embodiment, and for the simplicity and gradual disclosure of the invention, routes associated with a user (22) are imported manually (as opposed to automatically), by the user herself (22). Steps FD-3/305, FD-3/310, and FD-3/315 of the method for the automated collection of routes, are revealed in a later embodiment.

The information associated with the declaration of locations can include, indicatively:
i. The co-ordinates of location (e.g., address or latitude and longitude if these are known, or if they can be determined by the “Communication Device”) (1),
ii. The co-ordinates of routes (e.g., address or latitude and longitude of two or more locations—potentially including intermediate locations—along which the user knows she will commute),
iii. The estimated time in which she will be close to a particular location, or the estimated time when she will perform a particular itinerary,
iv. The frequency of performing itineraries (e.g., every day, or every Saturday)
v. The schedule for a particular itinerary (e.g., departure at 9:00 am, arrival at 9:50 am).

The declaration is received by the “Information Gateway server” (2), which examines the completeness of the data declared by the user (22), and forwards it to the “Locations & Routes Processing server” (10). This server (10) examines the correctness of the routes data (e.g., if the address exists and is sufficiently specified, if the declared time to perform the route is realistic, etc.), associates them with the specific user (22), and stores them on the “Locations & Routes Repository” server (11) (FD-3/320).

The routes information of the people in the Trusted Circle of a user (20) is exploited in step FD-2/215 of the method, as a criterion to select the most appropriate candidate carrier out of all the people in the users' Trusted Circle.

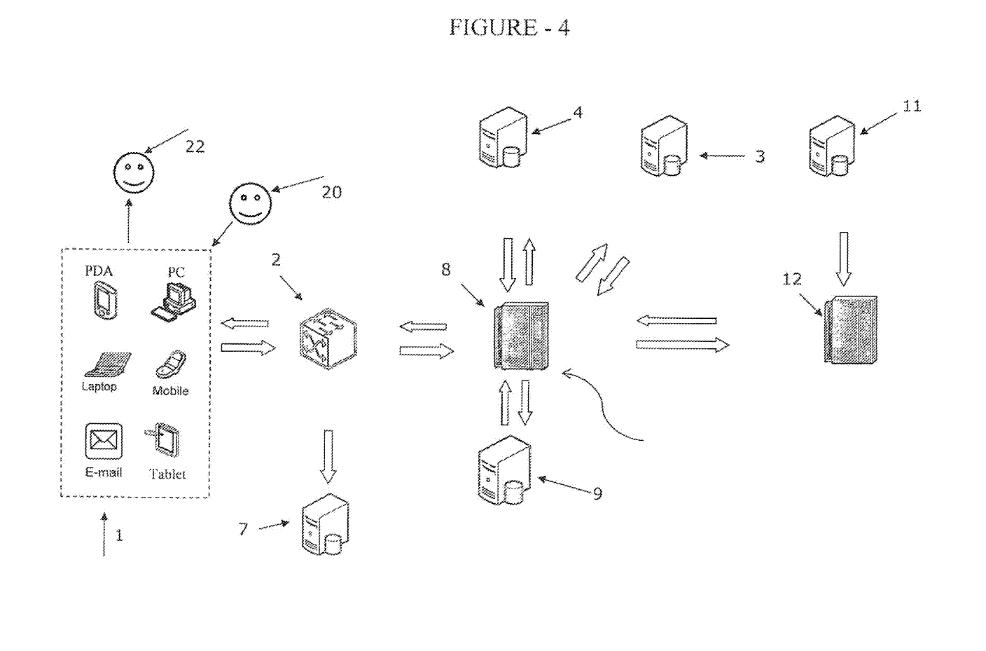

FIG. 4 amends and expands the process of FIG. 2 through which a user (20) searches for a person in his Trusted Circle that could help him. In addition to the actions depicted in FIG. 2, after storing the user (20) request in the “Pending Send Requests Repository” (7), and instead of forwarding the request to the users' Trusted Circle, the “Send and Transport Processing server” (8) delivers the request along with the list of people in the users' Trusted Circle, to the “Location & Routes Matching server” (12), in order for it to identify the person in the users' Trusted Circle that—based on his own declaration—is closer both in terms of space and time to the request to transport the users' object.

After identifying a person to satisfy the request, the “Send and Transport Processing server” (8) deletes the record of the pending request from the “Pending Send Requests Repository” (7), informs the “Matching Repository” (9) of the result, and notifies the user (20) who submitted the transportation request and the most suitable candidate from the Trusted Circle based on the declared itineraries, about the successful match (FD-2/240). In the specific embodiment, we assume that route declaration by users is binding, in the sense that they accept to transport an object if they are selected by the system. In later embodiments, the route declaration is non-binding.

The above messages for successful matching communicate to the two recipients the fact that a person from the users' Trusted Circle was chosen to serve the user (20) to transport the declared object from location A to location B. The successful matching messages may additionally include the necessary information for performing the transportation, such as the two locations, the dates and times for pickup and delivery, guidelines and instructions, etc. As with previous communications, the successful-matching messages are sent to the two recipients through the “Information Gateway server” (2).

### Embodiment 4

In another variation of Embodiment 3, the method and system of the invention may communicate with the trusted user that was chosen to transport the object, in order for him to finalize his intention to transport this object between the specified locations and at the specified times. In case he declines, the method and mechanism choose the next best candidate for the transport (steps FD-2/225, FD-2/230, and FD-2/235 of the method).

In connection with Embodiment 3, the additional communication for the final confirmation of the acceptance to perform the requested route, is done after the identification of the user to transport the object and before deleting the registered pending request from the “Pending Send Requests Repository” (7).

Specifically, the “Send and Transport Processing server” (8) sends a message to the user identified to transport the object (22), through the “Information Gateway server” (2), so that he can confirm his intention to transport the object between the specified locations and at the specified times.

Upon receiving the above message, the selected user (22) sends through “Communication Device” (1), either a message refusing the transportation, or a message confirming the acceptance to transport the object. In both cases, the refusal or acceptance message of the invitation to transport the object is received by the “Information Gateway server” (2), gets validated for its accuracy and where it originates form, and is forwarded to the “Send and Transport Processing server” (8).

Depending on the content of the statement in the received message, the “Send and Transport Processing server” (8):
i. continues with the next steps as described in Embodiment 3, in case of an acceptance confirmation, or
ii. notes the refusal statement in case of a refusal, and repeats the actions described in this variation of the invention, for the next trusted user that—based on his declaration—is geographically and temporally closer with respect to transporting the requested object, as detected by the “Locations & Routes Matching server” (12).

### Embodiment 5

In a variation of Embodiment 4, the invention uses the declared information of users regarding locations, routes, and possibly timeframes/schedules they can serve, to identify and select all the trusted people who meet specific geographic and temporal proximity criteria, to transport the specified object.

The method and system of the invention in Embodiment 5 are similar to Embodiment 4: steps FD-2/215 for the selection, and FD-2/225 for dispatching the invitation to transport the object, refer to all selected people and not just the best choice.

### Embodiment 6

In a variation of Embodiments 3, 4 and 5, if the method and system rule that the users who have stated their routes cannot serve the request (e.g., based on distance, time, or other restrictions such as schedules), the invention may also reach out to other or all persons in the users' Trusted Circle, in order to explore the possibility that either trusted users with undeclared routes or schedules can meet the declared transport request, and/or trusted users may volunteer to serve the request.

In this variation, in addition to what is described in Embodiments 3, 4 or 5, the “Send and Transport Processing server” (8) forwards the invitation to transport an object through the “Information Gateway server” (2), to people in the users' Trusted Circle, as described in Embodiment 1, with the potential exclusion of some people by the “Locations & Routes Matching server” (12).

In this Embodiment, the method FD-2/225 and the system generalize the previous embodiments, so that a trusted user that transports an object from a location A to a location B can be detected either automatically (if he has pre-declared a compatible route), or based on an invitation he receives and the corresponding acceptance he sends (if he has not pre-declared a compatible route).

### Embodiment 7

In another variation of Embodiment 3 (and its corollary variations described in Embodiments 4-6), the method and system combine the current locations and/or declared routes of users, to identify more than one person trusted by the user requesting the transportation of the object that can collectively serve the particular transportation request.

In this Embodiment, the transportation request is collectively satisfied by at least two users. In the simple case of transporting an object between two locations A and B by two users, the first user picks the object from location A, delivers it to the second user at a predetermined time at an agreed meeting point K, and the second user in turn delivers it to location B. In the more general case of more than two users, more than one meeting points are defined (in particular one less meeting point than the number of users involved in the transport of the object) where each user delivers the object to the next user (in a ‘baton’-like fashion) until the final delivery of the object to location B.

In this variation, in step FD-2/215, the “Locations & Routes Matching server” (12) examines the declared routes of users that belong to the Trusted Circle of the user requesting the transportation, and identifies the routes that:
a. intersect each other at a particular Intersection Point (or are close to each other in some of their points, based on defined geographical and temporal criteria (In these cases we broadly use the term [symbol] Intersection Point [symbol] to also mean the defined location where the two users can meet, even if their routes do not intersect), and
b. can in combination (i.e., the first part of the first route up to the Intersection Point, and the second part of the second route from the Intersection Point on) cover the entire route or part of the route between locations A and B, until they cover, complementary to each other, the entire route between locations A and B.

In case of identifying trusted users that can in combination cover the desired route, the “Send and Transport Processing server” (8) sends to each of them an invitation to transport an object—through the “Information Gateway server” (2)—only for the particular segment of the route that each of them can cover (step FD-2/225).

As in the previous embodiments, e.g., as described in Embodiment 3, upon receiving the above message, each selected user responds through the “Communication Device” (1), either refusing to accept the transportation request, or accepting to transport the object (step FD-2/230). However, unlike the previous embodiments (and after each message is received and considered as described—step FD-2/235), the “Send and Transport Processing server” (8) continues with the next steps described in Embodiment 3 only in the case where all the above users have accepted the corresponding transportation requests.

In case all the users accept the corresponding requests, the “Send and Transport Processing server” (8) communicates to the user (20) who requested the dispatch of the object and to the users who accepted it, a “match-found” message and the information necessary for the completion of the transportation, such as the pickup and delivery locations that correspond to the particular user, the date and time of the pickup and delivery, guidelines and directions, etc. (step FD-2/240). As with previous communications, informational messages regarding the successful matching are sent to the recipients via the “Information Gateway server” (2).

By combining routes of users, the invention ‘constructs’ new, non-registered routes. It therefore broadens the ‘coverage’ of a region and increases the probability of identifying users that can cater to a request to transport an object.

### Embodiment 8

In a variation of Embodiment 7, the combination of itineraries may be established on the basis of statements of the users receiving the call to transport an object. For example, a user who is unable to fully serve the transportation request alternatively denotes availability for partial fulfillment, i.e., offers to transport the object on a specific segment of the route (FD-2/230).

In this case, the “Send and Transport Processing server” (8) reviews the registered routes of users and sends additional and/or alternative invitations to the rest of the users in the Trusted Circle to cover the remainder of the requested route, and so on and so forth (Steps FD-2/235, FD-2/215, FD-2/225).

The method and system that implements this variation differ from that of Embodiment 7 in that the Intersection Points and one or more segments of the routes are identified sequentially and directly by the users (through their “Communication Devices” (1)), instead of by the “Locations & Routes Matching server” (12).

### Embodiment 9

In another variation of the invention (activation of steps FD-3/305 and FD-3/310 of the method), the mobile “Communication Devices” (1) of the users that declare availability to transport objects, automatically and periodically transmit the current coordinates or location to the “Information Gateway server” (2). These coordinates of the mobile “Communication Devices” (1) are stored in the “Locations & Routes Repository” (11) for use in the event that similar transport requests (based on coordinates/location) are registered. In this case, the “Locations & Routes Matching server” (12) has the ability to detect and select for the transportation, the trusted user that is closer to the object pickup point at that particular time.

In this embodiment of the invention, the method and system can serve in real time requests for emergency/immediate transportation of an object.

### Embodiment 10

In a variation of the invention, the user (20) sending a request to transport an object may also set a deadline by which she can wait until a trusted person that can transport the object is found (step FD-2/200), in addition to the description of the object (name, dimensional characteristics, weight, etc.) the specification of pickup/deliver locations, and the corresponding convenient times or timeframes referred to in Embodiment 1 also apply to the next embodiments.

Sending and processing of this additional deadline is included in the object transportation request, and is validated and processed simultaneously with the rest of the information in the request (steps FD-2/205 and FD-2/210). This deadline is used in step FD-2/235 as the time limit for waiting for an acceptance of the transportation invitation, and by the “Send and Transport Processing server” (8) to determine the time until which the transportation request object will remain in pending state, instead of the declared desired delivery time for the object as in the previous embodiments.

### Embodiment 11

In a variation of the invention, users (22) who may transport objects declare in advance the transportation options they have, such as the means of transport that they use (bicycle, car, etc.), the sizes/weights of objects that they can transport, whether they are willing to transport expensive or fragile objects, etc.

This additional information is used at step FD-2/215 by the “Send and Transport Processing server” (8) as an additional criterion, so that only trusted people meeting the specific transportation characteristics are sought and only targeted transportation invitations are sent.

### Embodiment 12

In another variation, the method and system of the invention may support the sending and/or receiving of messages upon the delivery of an object to its destination (step FD-2/250).

In this case, the user (20) who requested the dispatch of an object and/or the person (21) who undertook the transportation, send by means of the “Communication Devices” (1) a transportation completion message. The message is received by the “Information Gateway server” (2), is validated and forwarded to the “Send and Transport Processing server” (8). This server identifies the completion message with the corresponding entry in the “Matching Repository” (9) and updates the request as complete.

Accordingly, the method and system of the invention may support the sending and/or receiving of messages upon receipt of an object from its origin, so that it can maintain and provide information regarding the progress of the request (step FD-2/245).

### Embodiment 13

In another variation of the invention, a user can assign to each person in his Trusted Circle a specific Degree of Trust, depending on the confidence that he feels about this person for the transportation of specific objects.

The Degree of Trust may receive continuous values (e.g. in the range 0-10 or 0-1), but it can also receive discrete values (e.g., “blind” trust, “high” trust, “ordinary” trust, etc.). For example, a user may wish to select people of “high” trust for the transportation of personal belongings or valuables, whereas the same user may not have as strict criteria for the transportation of other objects, in which case “ordinary” trust would be sufficient.

The method and system of communication and dispatch of the transportation requests is equivalent to that of the previous embodiments. The difference lies in the fact that the Degree of Trust is saved at step FD-1/120 in the “Trust Network Repository” (4) and is taken into account in the selection criteria of users (step FD-2/215) in order to identify candidates of the Trusted Circle that will receive transportation invitation messages.

### Embodiment 14

In another variation, the invention may have a method and system for assigning, monitoring and managing the Degree of Trust of each user (e.g., by evaluating and collecting service fulfillment points or by assigning reliability points) based on the experience that other users had during their collaboration for the sending and/or transporting of objects.

In this variation, the User who requested the transportation (20) of an object and/or the User (21) who accepted it, send, by means of the “Communication Devices” (1), their evaluation with respect to the quality and reliability of the other party for the completion of the transportation, for example, whether the other party was punctual and the delivery and/or receipt was made in time, whether the object was described satisfactorily, whether the object was transported undamaged, whether communication between them was good, etc. This evaluation may consist of scores/ratings in many categories and take various forms, for example, continuous values in the range 0-10 or 0-1 or discrete values, e.g., “excellent”, “good”, “adequate”, “poor”.

Following embodiment 12, during step FD-2/255, the new message containing the evaluation of the user who requested the transportation of an object and/or the user who undertook it, is received by the “Information Gateway server” (2), validated and forwarded to the “Send and Transport Processing server” (8). This server identifies the evaluation message with the corresponding entry in the “Matching Repository” (9), potentially updates the request as complete (e.g., if not already done)—as in embodiment 12—and updates the Reliability Points of each user in the “Member Repository” (3) based on the evaluation given by the other part for the specific transportation.

### Embodiment 15

In another variation of the invention, the Trusted Circle of a user can be extended to additionally include people in the Trusted Circles of the people in said user's Trusted Circle.

In this variation, users are directed to an Extended Trusted Circle in order to find a trusted person who can complete their request: in addition to the people who they have directly included in their Trusted Circle, they extend their trust to all those people that the members of their Trusted Circle trust. In this case, users belonging to the Trusted Circle of another user are considered to be at distance 0 from this user (i.e., they are associated with a direct trust relationship) whereas users belonging to the Extended Trusted Circle are considered to be at distance 1 from the same user (i.e., they are associated with an indirect trust relationship, through users at distance 0).

By extension, the Extended Trusted Circle of users can be further generalized to additionally include people from the Trusted Circles of people in the Extended Trusted Circle, etc., who will be considered to be at distance 2, 3, etc. In general, the invention considers as a distance between two users the minimum number of users involved via their Trusted Circles, so that the second user is included in the Extended Trusted Circle of the first user.

The method and system implementing this embodiment is enriched only in step FD-2/215, when compiling the list of recipients of a transportation invitation message. Instead of forwarding the transportation invitation message only to persons in the user's Trusted Circle, in this variation of the invention, the “Send and Transport Processing server” (8) may also forward it to the people in the Extended Trusted Circle (step FD-2/225).

As in the previous embodiments, the sending of transportation invitation messages is performed by the “Information Gateway server” (2).

### Embodiment 16

In another variation of the invention, the Degree of Trust of the users is calculated parametrically: either exclusively by the user including them directly in the Trusted Circle at step FD-1/120 (e.g., when defining or modifying the Trusted Circle), or by a combination of the Degree of Trust and/or the users' evaluation and/or functions and parameters defined by such a method and system of the invention in step FD-2/255.

For example, if user A has included in his Trusted Circle another user B with a Degree of Trust equal to x (where 0≦x≦1) and user B has included in his own Trusted Circle a third user C with a Degree of Trust equal to y (where 0≦y≦1), then user A will “see” user C in his Extended Trusted Circle with a Degree of Trust equal to z, where z will be defined by such a method and system of the invention based on the Degrees of Trust x and y of users A and B, for example, it could be defined as z=x*y.

The above example is for illustrative purposes. In fact, this method and system of the invention may specify and implement correspondingly any mathematical, logical or other function or relationship or a combination thereof, taking into account the Degrees of Trust of these and other users, their Reliability Points and user evaluations. In addition, it may take into account the distance between users.

The execution of these functions and calculations is performed in step FD-2/215. The implementation of the method and system of this embodiment of the invention is equivalent to those of the basic embodiment of the invention with the modifications of embodiments 13 and 14 (for the assignment of Degrees of Trust and Reliability Points to users) and embodiment 15 (for the inclusion of users in the Extended Trust Circle when compiling the list of recipients of the transportation invitation messages).

### Embodiment 17

In another variation, the invention provides a method and system so that the user (20) requesting the transportation of an object can additionally select, based on criteria or nominally, which members of the Trusted Circle and the Extended Trusted Circle will receive transportation invitation messages. Indicative selection criteria may be the Degree of Trust of each user, the distance, other indices of reliability, personal or other subjective criteria, etc.

The choice of users may be performed either at the initial stage, where the user requests the transportation of an object, or/and at a later intermediate stage, after the compilation of an “initial” or “suggested” list of recipients that the “Send and Transport Processing server” (8) provides, but before the communication of the transportation invitation messages to members of this list.

Regarding the choice at the initial stage, the method and system of the invention allows the user to determine, along with the specification of the object to be transported and the locations and dates/time constraints, the selection criteria that must be satisfied by the recipients of the request (e.g., the minimum desired Degree of Trust in the recipients belonging to the Trusted Circle or the Extended Trusted Circle) (steps FD-2/200 and FD-2/215).

The selection at a later stage is described in step FD-2/220. It is performed after the compilation of the “initial” or “suggested” list of recipients (consisting of members of the Trusted Circle and the Extended Trusted Circle) based on the user's stored preferences in the “Trust Network Repository” (4). Specifically, the “Send and Transport Processing server” (8) through the “Information Gateway server” (2) shall prompt the user requesting the transportation to check and confirm or modify the “initial” or “suggested” list of recipients, before the transportation invitation messages are dispatched.

Responding to this prompt, the user who has requested the transportation can modify and/or approve the “initial” or “suggested” list and have it sent as “final”, through the “Communication Devices” (1). The “final” list is received by “Information Gateway server” (2), validated with respect to its accuracy and origin, and forwarded to the “Send and Transport Processing server” (8). The rest of actions in the flow chart remains the same, except that the “Send and Transport Processing server” (8) forwards the transportation invitation message only to the selected members in the “final” list of recipients.

### Embodiment 18

In another variation, the invention allows the dispatch of transportation invitation messages to users who meet specific criteria of trust (e.g., Degree of Trust, Reliability Points, other evidence of good cooperation, security deposit, etc.) even if they do not belong to Trusted Circle or Extended Trusted Circle of the user requesting the object's transportation.

This variation allows users to be able to serve other users, possibly unknown to them, by transporting objects for a fee, in exchange of other service, or for any other reason. At the same time, it allows users requesting the transportation of an object to broaden the list of recipients of their request to users who meet specific criteria of trust and cost (due to the aforementioned fee), in order to increase the probability to have their request served.

The method and system implementing this embodiment of the invention are parts of steps FD-2/215 and FD-2/220 and are equivalent to those of embodiments 13 to 17 with the clarification that, during the compilation of the list of recipients of transportation invitation messages, users not necessarily belonging to the requester's Trusted Circle or Extended Trusted Circle are retrieved from the “Locations & Routes Repository” (11) and included in the list, provided that they meet the criteria that the requester has specified as acceptable.

### Embodiment 19

In another variation of the previous embodiments, in step FD-2/210, the invention may also indicate the price of the object's transportation, which must be paid by the user (20) requesting the transportation to the user (21) transporting the object. In this case, the fee is additional information that supplements the transportation request, and also the messages for transportation invitation (FD-2/215), acceptance (FD-2/230 & FD-2/235), matching completion (FD-2/240) and transportation confirmation (FD-2/245 & FD-2/250), so that both parts (the user requesting the transportation and the user taking over it) are informed and approve.

### Embodiment 20

In another variation, the method and system of the invention allow users offering to transport objects to choose themselves when they are to be informed about pending requests and pending objects for transportation (step FD-2/225). In contrast to earlier variations of the invention where the “Send and Transport Processing server” (8) dispatches transportation invitation messages to users meet the criteria specified by the sender, in this variation, the users are informed of the pending requests when they so choose. For example, users can be informed about pending requests through appropriately posted information when they connect to use the invention, or when they explicitly request such information, or at user-specified regular time intervals, etc. Respectively, they can be informed about parts of an itinerary that another user has offered to cover, in order to consider to cover (part of) the remaining itinerary—in line with the variation of the method and system described in embodiment 8.

Following this disclosure, the method and system allows users to be able to choose which transportation request they will take over, out of all those that are pending, provided that they meet the sender's criteria.

### Embodiment 21

In yet another embodiment, the method and system considers the people of the Trusted Circle of the recipient as additional candidate people that can fulfill the transportation request. Assuming that the recipient of the object is already a user of the invention, or can become a user of the invention, the system and method searches for a proper match for each transportation request from a larger pool of trusted people, that includes both, the people that the sender trusts (including possibly those determined by other embodiments, e.g., Extended Trusted Circle, trusted people having complementary routes, people with an appropriate Degree of Trust or adequate Reliability Points) as well as the people the recipient trusts (including possibly those determined by other embodiments, e.g., Extended Trusted Circle, trusted people having complementary routes people with an appropriate Degree of Trust or adequate Reliability Points).

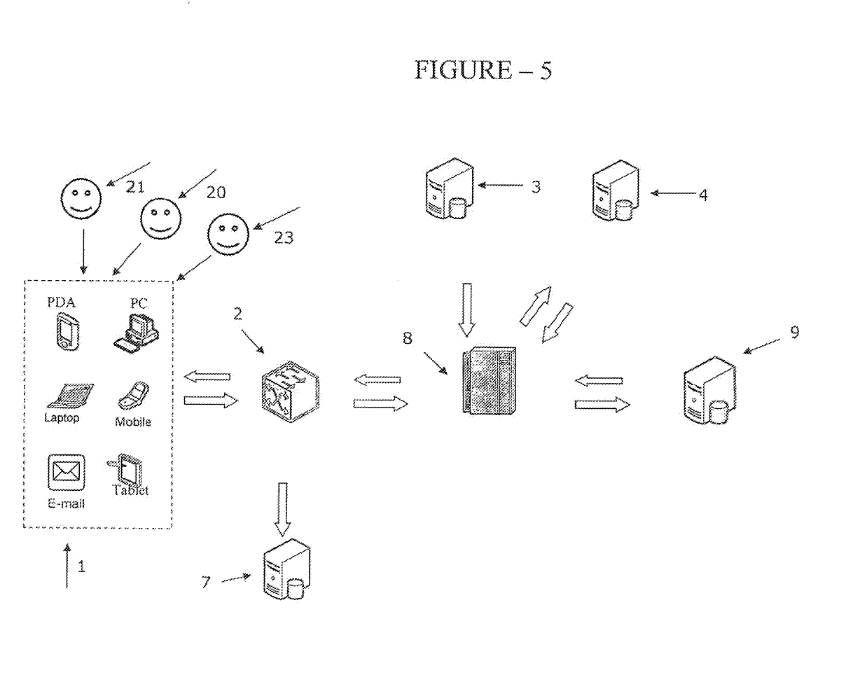

The necessary components comprising the system that implements this embodiment are the same. The difference lies in the fact that the recipient of the object, assumed to be a user of the invention (if not already a user, the invention assumes he will become a user following an invitation referral it sends him on behalf of the sender of the object), can also search within her Trusted Circle for a person (user or not) that can accommodate the need to transport of an object from location A to location B. The method and system that implements this embodiment is that of FIG. 2 and FD-2, with the adjustment shown in FIG. 5 and the alternative steps of FD-4. In this Flow Diagram, the User (20), together with the necessary information to request the transportation of an object (previously shown as FD-2/200), she also specifies the Recipient (23) of the object (e.g., via the Recipient's (23) email address, or via the Recipient's (23) social network contact id) (FD-4/400). The request is received (FD-4/405) by the Information Gateway server (2) and examined for its validity (FD-4/410). Then, it is forwarded to the Send and Transport Processing server (8) and stored in the Pending Send Requests Repository (7).

Subsequently, the Send and Transport Processing server (8) forks a parallel process to that of FD-2/215, that forwards to the said Recipient (23) of the object, through the Information Gateway server (2), an invitation to corroborate the transportation request (FD-4/415). After receiving the invitation, the Recipient (23) may choose to send via the Communication Device (1), an acceptance response to corroborate the request, which in turn, is received (FD-4/420) by the Information Gateway server (2), examined for its validity and origination and forwarded to the Send and Transport Processing server (8). Next, the Send and Transport Processing server (8) follows steps FD-4/425 and FD-4/430 which are identical to that of FD-2/215 and FD-2/220, except that they are carried out on behalf of the Recipient (23).

The rest of actions remain the same, as described in FD-2, with the only provision being that the Information Gateway server (2), will also notify the Recipient (23) for every change in the status of the transportation request, as it does with the User (20), e.g., in steps FD-2/240 and those that follow.

### Embodiment 22

In another variation of the invention, the transportation may concern not objects but people or animals or other living beings. Without substantial differences, the invention may be used so that a user (20) can locate other trusted users and make arrangements with them to transport to another location himself, other people. If the invited user belongs to the Extended Trusted Circle or is unknown to the requester, the matching may be based on additional criteria (step FD-2/215) including the age, gender, family profile, interests, educational level of the two users, etc.

### EXPLOITATION OF THE INVENTION IN INDUSTRY

The invention can be used in the postal and couriers service industries as well as the transportation services industry. Moreover, it can be used as a value added service to customers of social networking services, as well as industry organizations providing mediation services, information service and information brokerage.

Additionally, the invention can be used by stores selling goods for finding people who can transport the purchased goods to their customers and who enjoy the trust of the stores or their clients, as an alternative to the use of postal or transport services (e.g., couriers, delivery, etc.). Similarly, it can be used by companies providing postal or transport services as an alternative mode of transport to and from the final distribution centers (points that deal directly with customers picking up or handing over objects) improving the “last mile problem”.

Additionally, the invention can be exploited in the industry manufacturing electronic maps which, with appropriate customization or the embedding of specialized software, may provide information services in a very simple and integrated way, informing users of current transportation requests for objects or persons and assisting them in their communication with the central system for collecting, processing and management of such information.

Further, the invention may be used in the industry manufacturing navigation devices and/or related software and/or search engines.

In general, the foregoing description is provided for exemplary and illustrative purposes; the present invention is not necessarily limited thereto. Rather, those skilled in the art will appreciate that additional modifications, as well as adaptations for particular circumstances, will fall within the scope of the invention as herein shown and described and the claims appended hereto.

1. A computer-based system for facilitating transportation based on trust relationships between persons, the system comprising at least one network-connected computer device configured with program instructions to:
receive a transportation request from a requester;
automatically identify at least one eligible person to fulfill the transportation request from among a plurality of persons based on identification of a trust relationship with the requester; and
send the transportation request to the at least one eligible person prior to receiving any trust relationship input therefrom.

2. The system of claim 1, wherein the at least one network-connected computer device is further configured with program instructions to identify a plurality of trust relationships between a respective plurality of persons and the requester.

3. The system of claim 2, wherein identifying the plurality of trust relationships includes receiving an input of a plurality of trusted persons from the requester.

4. The system of claim 3, wherein receiving the input of the plurality of trusted persons from the requester includes receiving a specification of a trusted person and related information.

5. The system of claim 3, wherein receiving the input of the plurality of trusted persons from the requester includes receiving a specification of at least one external source from the requester and importing information on trusted persons therefrom.

6. The system of claim 5, wherein receiving the specification of at least one external source from the requester includes receiving a specification of at least one of:
a social networking website;
an address book; and
an email list.

7. The system of claim 5, wherein importing information on trusted persons from the at least one external source includes displaying the imported information to the requester for review and soliciting modifications thereto.

8. The system of claim 3, wherein receiving the input of the plurality of trusted persons from the requester includes verifying the sufficiency of information input regarding the plurality of trusted persons.

9. The system of claim 2, wherein identifying the plurality of trust relationships includes identifying a plurality of trusted persons having indirect trust relationships with the requester.

10. The system of claim 9, wherein identifying the plurality of trusted persons having the indirect trust relationships with the requester includes tracking corresponding distances of the indirect trust relationships, each of the distances indicative of a number of indirect trust relationships between a respective trusted person and the requester.

11. The system of claim 2, wherein identifying the plurality of trust relationships includes identifying corresponding degrees of trust.

12. The system of claim 11, wherein identifying the corresponding degrees of trust of the plurality of trust relationships includes receiving inputs of the corresponding degrees of trust from the requester.

13. The system of claim 11, wherein identifying the corresponding degrees of trust of the plurality of trust relationships includes automatically updating the corresponding degrees of trust based on received feedback relating to performance of previous transportation requests.

14. The system of claim 2, wherein the requester is designated as a first party to the transportation request, the transportation request further includes a designation of a second party, and identifying the plurality of trust relationships includes identifying trust relationships with the second party.

15. The system of claim 1, wherein receiving the transportation request from the requester includes receiving a specification of at least one object or at least one person to be transported.

16. The system of claim 15, wherein receiving the transportation request from the requester includes designating a level of trust required for the at least one eligible person.

17. The system of claim 16, wherein the at least one network-connected computer device is further configured to automatically identify at least one eligible person to fulfill the transportation request from among a plurality of persons based on identification of the level of trust associated with the trust relationship.

18. The system of claim 17, wherein identifying the level of trust associated with the trust relationship is based on at least one of: a corresponding degree of trust, a corresponding distance indicative of a number of indirect trust relationships between a respective trusted person and the requester, and both the corresponding degree of trust and the corresponding distance.

19. The system of claim 1, wherein the at least one network-connected computer device is further configured to automatically identify at least one eligible person to fulfill the transportation request from among the plurality of persons based on a route of the transportation request.

20. The system of claim 19, wherein automatically identifying the at least one eligible person to fulfill the transportation request from among the plurality of persons based on the route of the transportation request includes comparing the route of the transportation request with corresponding prospective routes of the plurality of persons.

21. The system of claim 20, wherein the at least one network-connected computer device is further configured to receive prospective route data from the plurality of persons.

22. They system of claim 21, wherein receiving the prospective route data from the plurality of persons includes receiving inputs specifying the corresponding prospective routes from the plurality of persons.

23. The system of claim 21, wherein receiving the prospective route data from the plurality of persons includes automatically determining the corresponding prospective routes based on position data received from the plurality of persons.

24. The system of claim 23, wherein comparing the route of the transportation request with corresponding prospective routes of the plurality of persons includes identifying, based on the received position data, which of the plurality of persons is currently most proximate to an origin point of the transportation request.

25. The system of claim 19, wherein the at least one network-connected computer device is further configured to automatically identify a plurality of eligible persons to fulfill the transportation request from among the plurality of persons based on identification of trust relationships with the requester and the route of the transportation request, and
wherein the at least one network-connected computer device is further configured to:
send the transportation request to the plurality of eligible persons; and
receive a first reply from a first of the plurality of eligible persons confirming willingness to perform a first portion of the route of the transportation request; and
receive a second reply from a second of the plurality of eligible persons confirming willingness to perform a second portion of the route of the transportation request.

26. The system of claim 25, wherein the at least one network-connected computer device is further configured to send a coordination message to the first and second of the plurality of eligible persons with interchange information.

27. The system of claim 1, wherein the at least one network-connected computer device is further configured to:
receive an affirmative reply to the transportation request from the at least one eligible person; and
send a notification message to the requester regarding the affirmative reply.

28. The system of claim 1, wherein the at least one network-connected computer device is further configured to:
receive confirmation of completion of the transportation request; and
send a notification message to the requester regarding the completion.

29. The system of claim 1, wherein the at least one network-connected computer device is further configured to:
send a notification message to the requester regarding the at least one eligible person identified; and
receive an approval of the at least one eligible person identified from the requester before sending the transportation request thereto.

30. The system of claim 1, wherein receiving the transportation request from the requester includes receiving a specification of at least one physical characteristic of at least one object or at least one person to be transported, and
wherein the at least one network-connected computer device is further configured to automatically identify at least one eligible person to fulfill the transportation request from among the plurality of persons based on a determination of compatibility between the at least one physical characteristic and a mode of transportation associated with the at least one eligible person.
